(19) United States
(12) Patent Application Publication
(10) Pub. No.: US 2025/0155697 A1
(43) Pub. Date: May 15, 2025

(54) BIOLOGICAL FLUID ANALYSER WITH ADAPTIVE LIGHT SOURCE ASSEMBLY

(71) Applicant: Radiometer Medical ApS, Brønshøj (DK)

(72) Inventors: Peter Emil LARSEN, Brønshøj (DK); Thomas Steen HANSEN, Brønshøj (DK); Mohammad Esmail ARYAEE PANAH, Brønshøj (DK)

(21) Appl. No.: 18/722,185

(22) PCT Filed: Dec. 22, 2022
(86) PCT No.: PCT/EP2022/087486

§ 371 Date: Jun. 20, 2024

(30) Foreign Application Priority Data
Dec. 23, 2021 (EP) 21217288.6

(51) Int. Cl. G02B 21/36; G01N 15/1434

(52) U.S. Cl. CPC G02B 21/361; G01N 15/1434; G01N 2015/144

(57) ABSTRACT

A biological fluid analyser is provided, the biological fluid analyser comprising an imaging system comprising a light source assembly configured to emit light; a first lens assembly configured to direct the light from the light source assembly to directly or indirectly define a probing light; the imaging system defining a probing volume configured to receive probing light and configured to receive a container comprising a prepared biological fluid sample; the biological fluid analyser comprising a controller configured to control the light source assembly according to a light configuration, wherein the light source assembly, in response to a first light control signal, is configured to emit light according to a first light configuration, and wherein the light source assembly, in response to a second light control signal, is configured to emit light according to a second light configuration.

The present invention relates to analysis of biological fluid samples, such as blood samples or cell culture samples, and to tools, methods and systems used to carry out such biological fluid sample analyses. More particularly, the present invention relates to biological fluid analysers for analysing biological fluid samples.

### BACKGROUND

The analysis of a biological fluid sample, such as the determination of a blood parameter or a cell culture parameter, may be lengthy and may require a significant number of preparatory steps, resources, and advanced dedicated pieces of equipment.

### SUMMARY

Accordingly, there may be a need for a biological fluid analyser which may allow for an improved biological fluid sample analysis.

Accordingly, a biological fluid analyser is provided. The biological fluid analyser comprises an imaging system. The imaging system comprises a light source assembly configured to emit light. The imaging system comprises a first lens assembly configured to direct the light from the light source assembly. The imaging system defines a probing volume configured to receive the probing light and configured to receive a container comprising a prepared biological fluid sample. The biological fluid analyser may comprise a controller.

The controller may be configured to control the imaging system according to a probing light configuration. For example, the controller may be configured to provide a first probing light control signal to the imaging system for applying a first probing light configuration in the imaging device. For example, the controller may be configured to provide a second probing light control signal to the imaging system for applying a second probing light configuration in the imaging device. The imaging device is configured to, when applying a first probing light configuration, provide first probing light, and when applying a second probing light configuration, provide second probing light different from the first probing light, e.g., having different incidence angles and/or incidence angle ranges. Hereby, a biological fluid analyser is provided that allows for a wide range of analyses, e.g., of different types of samples and cell types.

The controller may be configured to control the light source assembly according to a light configuration. The light source assembly, in response to a first light control signal, may be configured to emit light according to a first light configuration. In other words, the first probing light control signal may comprise the first light control signal. The light source assembly, in response to a second light control signal, may be configured to emit light according to a second light configuration. In other words, the second probing light control signal may comprise the second light control signal.

The biological fluid analyser may be beneficial to provide more efficient biological fluid sample analyses.

For example, a more precise, robust, and rapid image-based biological fluid parameter determination or estimation may be achieved. An example of biological fluid parameter is a blood parameter being a platelet concentration in a blood sample. The determination or estimation of biological fluid parameters may be useful, e.g., for blood cell classification purposes, such as the determination, classification, or estimation of cell types in a blood sample or other cell classification purposes, such as the determination, classification, or estimation of cell types in a cell culture sample. The biological fluid analyser may enable quick cell classification with higher accuracy and reliability, without having to rely on more expensive optical elements.

By providing a controller configured to control the light source assembly, the biological fluid analyser may advantageously control and adjust the properties of a probing light in a versatile manner, that is, the probing light may be adjusted according to a wider range of probing light parameters and in a more accurate manner. This may be useful to determine or estimate a greater amount of biological fluid parameters, which may improve the determination or estimation of cell types in the biological fluid sample.

By providing a controller, a customization of the biological fluid sample analyses may be achieved. For example, by providing an aperture device and a controller configured to control the aperture device, the light source assembly or both the aperture device and the light source assembly, the biological fluid analyser may advantageously control and adjust the properties of a probing light. Since the properties of the probing light may affect the biological fluid parameter determination or estimation in a biological fluid sample, the customization of the probing light may advantageously provide more information about the biological fluid sample, such as information to determine or estimate cell types in the biological fluid sample, without a need for dedicated optical elements.

### BRIEF DESCRIPTION OF THE DRAWINGS

The above and other features and advantages of the present disclosure will become readily apparent to those skilled in the art by the following detailed description of exemplary embodiments thereof with reference to the attached drawings, in which:

FIG. 1 depicts a schematic longitudinal cross-section of a biological fluid analyser in which an aperture device has a second aperture configuration,

FIG. 2 schematically shows the biological fluid analyser of FIG. 1 at an instant in which the aperture device has a first aperture configuration,

FIG. 3 schematically illustrates an aperture device comprising blades and a blade aperture,

FIG. 4 schematically represents an aperture device comprising a plate,

FIG. 5 schematically shows an aperture device comprising a glass substrate with a first transparency pattern,

FIG. 6 schematically shows the aperture device of FIG. 5 at an instant when the glass substrate has a second transparency configuration,

FIG. 7 schematically depicts a biological fluid analyser in which a light source assembly has a second light configuration,

FIG. 8 schematically illustrates the biological fluid analyser of FIG. 7 at an instant when the light source assembly has a first light configuration,

FIG. 9 schematically represents a light source assembly having a first geometrical pattern corresponding to a first light configuration, and

FIG. 10 schematically shows the light source assembly of FIG. 9 at an instant when the light source assembly has a second geometrical pattern corresponding to a second light configuration.

### DETAILED DESCRIPTION

Various example biological fluid analysers are described hereinafter, with reference to the figures when relevant. It should be noted that the figures may or may not be drawn to scale. It should also be noted that the figures are only intended to facilitate the description of various embodiments. They are not intended as an exhaustive description of the invention or as a limitation on the scope of the invention. In addition, an illustrated embodiment needs not have all the aspects or advantages shown.

An aspect or an advantage described in conjunction with a particular embodiment is not necessarily limited to that embodiment and can be practiced in any other embodiments even if not so illustrated, or if not so explicitly described.

The figures are schematic and simplified for clarity, and they merely show details which aid understanding the disclosure, while other details have been left out. Throughout, the same reference numerals are used for identical or corresponding parts.

As used herein, “imaging system” denotes a system comprising optical elements configured for enabling a graphic representation of body samples or parameters of body samples. For example, in a biological fluid analyser, the imaging system may enable a graphic representation of the cell types contained in a prepared blood sample or cell culture analysed by the biological fluid analyser.

In one or more example biological fluid analysers, a biological fluid analyser is provided, the biological fluid analyser comprising an imaging system comprising a light source assembly configured to emit light; a first lens assembly configured to direct the light from the light source assembly to directly or indirectly define a probing light; the imaging system defining a probing volume configured to receive probing light and configured to receive a container comprising a prepared biological fluid sample; and the biological fluid analyser comprising a controller configured to control the light source assembly according to a light configuration, wherein the light source assembly, in response to a first light control signal, is configured to emit light according to a first light configuration, and wherein the light source assembly, in response to a second light control signal, is configured to emit light according to a second light configuration different from the first light configuration.

The biological fluid analyser may be a blood analyser. In other words, the biological fluid analyser may be configured to analyse human blood and/or animal blood, such as, e.g., mammal blood. Thus, the prepared biological fluid sample may be a prepared blood sample.

The biological fluid analyser may be a cell culture analyser. In other words, the biological fluid analyser may be configured to analyse cell cultures, such, e.g., culture of cells derived from multicellular eukaryotes, such as, e.g., mammalian cells, animal cells, and/or human cells; and/or culture of cells grown from plant tissue culture, fungal culture, and/or microbiological culture (of microbes). Thus, the prepared biological fluid sample may be a prepared cell culture sample.

Further, a method of operating a biological fluid analyser, such as a biological fluid analyser disclosed herein, is provided, the method comprising emitting, with a light source assembly, light; directing, e.g., with a first lens assembly, the light to directly or indirectly define a probing light; and receiving probing light in a probing volume, wherein emitting light with a light source comprises emitting light according to a first light configuration in response to a first light control signal, e.g. from a controller, and emitting light according to a second light configuration in response to a second light control signal, e.g. from the controller.

A light source assembly may be formed from a supporting element which supports a plurality of light sources, such as a plurality of LEDs. The light source assembly may comprise electrical circuitry to provide electric power to the plurality of light sources.

A lens assembly, such as one or more of the first lens assembly, the second lens assembly, and the third lens assembly, may be formed from one or more lenses. The one or more lenses of a lens assembly may be arranged to direct the received light according to a desired light pattern. For example, a lens assembly may be configured to direct received light towards a rear focal point of the lens assembly. The configuration of a lens assembly to achieve the desired light pattern is well-known. This may be achieved by a suitable combination of lenses, such as convex and concave lenses, having suitable indices of refraction.

The imaging system may comprise an aperture device, e.g., configured to apply an aperture to allow light from the first lens assembly to pass through the aperture, e.g., in order to indirectly define a probing light. Put another way, the aperture device may block part of the light directed from the first lens assembly. The aperture device may thus advantageously filtrate the light downstream of the aperture device by selecting the light that passes through the applied aperture.

The controller may be configured to control the aperture device according to an aperture configuration. The aperture device, in response to a first aperture control signal, may be configured to apply an aperture with a first aperture configuration. In other words, the first probing light control signal may comprise the first aperture control signal. The aperture device, in response to a second aperture control signal, may be configured to apply an aperture with a second aperture configuration. In other words, the second probing light control signal may comprise the second aperture control signal.

By providing a controller configured to control the aperture device and the light source assembly, the biological fluid analyser may advantageously enable to adapt the adjustment of a probing light to the characteristics of the biological fluid analyses, for example by relying on the control of the light source assembly, or simultaneously both the light source assembly and the aperture device, when a precise adjustment of the probing light is required, and by relying on the control of the aperture device when cost efficiency is desired.

In one or more example biological fluid analysers, first probing light provided in response to the first probing light control signal, such as the first aperture control signal and/or the first light control signal, may comprise light having an incident light angle with regard to the optical axis less than a first upper light angle. The first upper light angle may be 15 degrees or less than 15 degrees, such as 15 degrees or less than 10 degrees or even 5 degrees or less than 5 degrees. In one or more example biological fluid analysers, first probing light provided in response to the first probing light control signal, such as the first aperture control signal and/or the first light control signal does not have light or substantially no light having an incident light angle with regard to the optical axis larger than the first upper light angle.

In one or more example biological fluid analysers, first probing light provided in response to the first probing light control signal, such as the first aperture control signal and/or the first light control signal, may comprise light having an incident light angle with regard to the optical axis larger than a first lower light angle. The first lower light angle may be 0 degrees or larger than 0 degrees, such as 2 degrees or larger than 2 degrees, 5 degrees, or larger than 5 degrees, or 10 degrees or larger than 10 degrees. In one or more example biological fluid analysers, first probing light provided in response to the first probing light control signal, such as the first aperture control signal and/or the first light control signal does not have light or substantially no light having an incident light angle with regard to the optical axis less than the first lower light angle.

The first lower light angle and the first upper light angle may define a first light angle range of the first probing light. The first light angle range may be from 0 degrees to 15 degrees, such as from 0 degrees to 10 degrees, e.g., from 5 to 10 degrees.

In other words, the imaging system may be configured to selectively provide first probing light comprising light with only incident light angle within the first light angle range.

In one or more example biological fluid analysers, second probing light provided in response to the second probing light control signal, such as the second aperture control signal and/or the second light control signal, may comprise light having an incident light angle with regard to the optical axis less than a second upper light angle. The second upper light angle may be 30 degrees or less than 30 degrees, such as 20 degrees or less than 20 degrees or even 17 degrees or less than 17 degrees. In one or more example biological fluid analysers, second probing light provided in response to the second probing light control signal, such as the second aperture control signal and/or the second light control signal does not have light or substantially no light having an incident light angle with regard to the optical axis larger than the second upper light angle.

In one or more example biological fluid analysers, second probing light provided in response to the second probing light control signal, such as the second aperture control signal and/or the second light control signal, may comprise light having an incident light angle with regard to the optical axis larger than a second lower light angle. The second lower light angle may be larger than the first upper light angle. The second lower light angle may be 0 degrees or larger than 0 degrees, such as 2 degrees or larger than 2 degrees, 5 degrees or larger than 5 degrees, or 10 degrees or larger than 10 degrees. In one or more example biological fluid analysers, second probing light provided in response to the second probing light control signal, such as the second aperture control signal and/or the second light control signal does not have light or substantially no light having an incident light angle with regard to the optical axis less than the second lower light angle.

The second lower light angle and the second upper light angle may define a second light angle range of the second probing light. The second light angle range may be from 0 degrees to 20 degrees, such as from 5 degrees to 20 degrees, e.g., from 10 to 17 degrees. The second light angle range and the first light angle range may be non-overlapping.

In other words, the imaging system may be configured to selectively provide second probing light comprising light with only incident light angle within the second light angle range.

In one or more example biological fluid analysers, the first light configuration defines a first probing volume, wherein the second light configuration defines a second probing volume, and wherein at least part of the first and second probing volumes overlap. In some examples, at least 90%, at least 70%, or least 50% of the first and second probing volumes overlap. The biological fluid analyser may be configured to keep the probing volume, and potentially also the container, stationary during, e.g., change from the first light configuration to the second light configuration. Additionally, or alternatively, this allows imaging of at least part of the same volume of the prepared biological fluid with the light device in the first light configuration and the second light configuration. This may be particularly advantageous in combination with example biological fluid analysers, wherein the imaging system is configured to selectively provide first probing light comprising light with only incident light angle within the first light angle range and/or the imaging system is configured to selectively provide second probing light comprising light with only incident light angle within the second light angle range as this allows effective acquiring of image data of at least part of the same volume of prepared biological fluid sample acquired with different incident light angles.

In one or more example biological fluid analysers, the biological fluid analyser defines an optical path corresponding to that of a transmission microscope. In other words, the imaging system may be configured to obtain image data from probing light having been transmitted through the probing volume. This allows imaging of the prepared body fluid sample without having to rely solely on florescence emitted by the prepared fluid analyser. Additionally, this may allow improved simplicity and reduced footprint of the biological fluid analyser, which may be particularly useful for cell classification, particularly in a point of care and/or bedside setting. Additionally, it may allow the biological fluid analyser to obtain an image stack of images planes for richer image data and potentially improved cell classification.

In one or more example biological fluid analysers, a biological fluid analyser is provided, the biological fluid analyser comprising an imaging system comprising a light source assembly configured to emit light; a first lens assembly configured to direct the light from the light source assembly; an aperture device configured to apply an aperture to allow light from the first lens assembly to pass through the aperture in order to indirectly define a probing light; the imaging system defining a probing volume configured to receive the probing light and configured to receive a container comprising a prepared biological fluid sample; the biological fluid analyser comprising a controller configured to control the aperture device according to a first configuration, wherein the aperture device, in response to a first aperture control signal, is configured to apply an aperture with a first aperture configuration, and wherein the aperture device, in response to a second aperture control signal, is configured to apply an aperture with a second aperture configuration.

By providing an aperture device and a controller configured to control the aperture device, the biological fluid analyser may advantageously control and adjust the properties of a probing light without a need for a customisation of more complex components of the imaging system, such as the light source assembly, the first lens assembly, the second lens assembly, any other suitable component of the imaging system or a suitable combination of them. Put another way, the biological fluid analyser may provide for an inexpensive, easy-to-maintain solution to allow for an adjustment of the properties of the probing light.

The controller may be configured to modify the aperture configuration by means of aperture control signals. In other words, the controller may apply an aperture according to at least a first aperture configuration and a second aperture configuration. The controller may also apply an aperture according to additional aperture configurations different from the first aperture configuration and the second aperture configuration. For example, the aperture device, in response to a third aperture control signal, may be configured to apply an aperture with a third aperture configuration.

By providing different aperture configurations, the properties of the light passing through the applied aperture may be customised.

The light passing through the applied aperture indirectly defines a probing light. The term “to indirectly define” describes that the light passing through the applied aperture must be directed by one or more optical elements downstream of the aperture device to form the probing light.

As used herein, “probing light” is light configured to be received by a probing volume configured to receive a container comprising a prepared blood sample or cell culture. Put another way, the probing light is configured to be received by the container comprising the prepared blood sample or cell culture when the container is received in the probing volume.

By changing the aperture configuration, the properties of the probing light change accordingly. For example, the first aperture configuration may give rise to probing light with a first incidence angle whilst blocking probing light having a second incidence angle. The second aperture configuration may give rise to probing light with a first incidence angle and a second incidence angle.

Since the properties of the probing light may affect the blood or cell parameter determination or estimation in a prepared blood sample or the cell culture parameter determination or estimation in a cell culture sample, the customisation of the probing light may advantageously provide more information about the blood sample or cell culture sample, such as information about cell types in the blood sample or in the cell culture sample, in a robust and rapid manner without a need for further dedicated optical elements. For example, probing light with a first incidence angle may be suitable for determining or estimating a first cell type or first blood cell type. Probing light with a second incidence angle may be suitable for determining or estimating a second cell type or second blood cell type. In other words, probing light with different incident light settings/incidence angles may allow for improved cell classification based on respective image data of the cells with different incident light settings.

The light directed by the first lens assembly directly or indirectly defines a probing light. The term “to indirectly define” means that the light directed by the first lens assembly must be directed by one or more optical elements downstream of the first lens assembly to form the probing light. The term “to directly define” means that the light directed by the first lens assembly forms the probing light with no optical elements downstream of the first lens assembly.

The controller may be configured to control the light source assembly by means of light control signals. In other words, the controller may control the light source assembly according to at least a first light configuration and a second light configuration. The controller may also control the light source assembly according to additional light configurations different from the first light configuration and the second light configuration.

For example, the light source assembly, in response to a third light control signal from the controller, may be configured to emit light according to a third light configuration.

By providing different light configurations, the properties of the light emitted by the light sources of the light source assembly may be customised, which in turn allows precise control and customization of the probing light.

The light directed from the first lens assembly is received from the light source assembly. Therefore, when the light directed by the first lens assembly directly or indirectly defines a probing light, the probing light depends on the light configuration of the light emitted by the light source assembly. By changing the light configuration of the light source assembly, the properties of the probing light may change accordingly. For example, the first light configuration may give rise to probing light with a first incidence angle. The second aperture configuration may give rise to probing light with a first incidence angle and a second incidence angle.

Since the properties of the probing light may affect the blood or cell parameter determination or estimation in a prepared biological fluid sample, the customisation of the probing light may advantageously provide more information about the biological fluid sample, such as information to determine or estimate cell types in the biological fluid sample, in a reliable and rapid manner without a need for further dedicated optical elements.

In one or more example biological fluid analysers, the imaging system comprises a second lens assembly configured to direct light from the aperture device. In other words, the light passing through the applied aperture is directed by the second light assembly to constitute the probing light. The second lens assembly may be useful to concentrate the probing light on the probing volume. For example, the probing volume may be disposed at a rear focal plane of the second lens assembly.

In one or more example biological fluid analysers, the biological fluid analyser comprises a container configured to contain a prepared biological fluid sample. The container may be received in the probing volume. The container may also be denoted a cuvette. The cuvette may be a multi-use or a single-use cuvette. In one or more example biological fluid analysers, wherein the cuvette is a multi-use cuvette, the biological fluid analyser may be configured as a multi-use device comprising the necessary fluidic system and mechanics for conducted a plurality of measurements. Such example biological fluid analysers may further comprise a solution pack comprising one or more solutions, which the example biological fluid analyser is configured to administer and release by use of its fluidic system and mechanics to automatically at least partially prepare the prepared body fluid sample after aspiration and is configured to control the fluidic system to perform a cleaning program of at least the multi-use cuvette prior and/or post biological fluid analysis.

The prepared biological fluid sample may comprise a blood sample prepared with one or more reagents, chemicals, treatments and/or processes. The prepared biological fluid sample may be a prepared blood sample and may for example comprise a blood sample which has been stained, such as chemically stained. The prepared blood sample may for example comprise a blood sample which has been hemolyzed, for example, wherein most of the red blood cells in the blood sample have been removed. The prepared blood sample may for example comprise a blood sample which has been fixed, such that substantially no cell movement occurs while acquiring the images of the prepared blood sample. The prepared blood sample may be understood as a solution comprising blood and one or more reagents and/or chemicals. The prepared blood sample may be understood as a dissolution, such as a dissolved blood sample. The prepared blood sample may be placed in a container, such as a cuvette. When the container is received in the probing volume, the biological fluid analyser may analyse blood properties of the prepared blood sample.

In one or more example biological fluid analysers, the container comprises a container lens assembly configured to direct light from the aperture device. To put it differently, the light passing through the applied aperture may be directed by the container lens assembly to constitute the probing light. The provision of the container lens assembly may be beneficial in that, since the optical elements directing light from the aperture device are integral with the container, the container lens assembly may be tailored to the type and position of the prepared biological fluid sample included in the container.

In one or more example biological fluid analysers, the aperture device comprises a blade aperture. The aperture device, in response to the first aperture control signal, may be configured to adjust the blade aperture as the aperture with a first aperture configuration. The aperture device, in response to the second aperture control signal, may be configured to adjust the blade aperture as the aperture with a second aperture configuration.

An aperture blade may be an advantageous solution to efficiently and accurately apply apertures with varying configurations, such as apertures with varying sizes, shapes or both sizes and shapes.

In one or more example biological fluid analysers, the aperture device comprises a plate with a first plate aperture and a second plate aperture different from the first plate aperture. The aperture device, in response to the first aperture control signal, may be configured to apply the first plate aperture as the aperture with a first aperture configuration. The aperture device, in response to the second aperture control signal, may be configured to apply the second plate aperture as the aperture with a second aperture configuration.

A plate with a first plate aperture and a second plate aperture may allow for an arrangement to apply apertures with varying configuration which is reliable and easy to manufacture and maintain.

In one or more example biological fluid analysers, the aperture device comprises an actuator. The actuator, in response to the first aperture control signal, may be configured to move the plate to a first position. The actuator, in response to the second aperture control signal, may be configured to move the plate to a second position. The actuator may be useful to automatise the application of apertures by linking the controller to the plate.

In one or more example biological fluid analysers, the aperture device comprises a glass substrate. The aperture device, in response to the first aperture control signal, may be configured to apply a first transparency pattern in the glass substrate for provision of the aperture with a first aperture configuration. The aperture device, in response to the second aperture control signal, may be configured to apply a second transparency pattern in the glass substrate for provision of the aperture with a second aperture configuration.

The provision of first and second transparency patterns may lead to a versatile and precise selection of apertures with different aperture configurations.

The glass substrate may comprise a liquid crystal display. Liquid crystal displays may be configured to accurately provide varying transparency patterns.

The aperture with a first aperture configuration may have a first diameter in the range from 0.5 mm to 4 mm. The aperture with a second aperture configuration may have a second diameter in the range from 2 mm to 8 mm. Such dimensions of the aperture with a first aperture configuration and the aperture with a second aperture configuration may lead to variations in the probing light that may be useful for the determination or estimation of a larger number of blood properties in a prepared blood sample and/or a larger number of cell culture properties in a prepared cell culture sample.

The aperture with a third aperture configuration may have a third diameter in the range from 3 mm to 10 mm.

The application of an aperture with a first aperture configuration may comprise decentring the aperture from an optical axis of the imaging system. The application of an aperture with a second aperture configuration may comprise decentring the aperture from the optical axis. As used herein, “to decentre the aperture from the optical axis” is understood as to place the aperture offset from the optical axis.

By applying apertures decentred from the optical axis, probing light with a characteristic suitable for the determination or estimation of a given biological fluid parameter may be achieved. For example, probing light with an incident angle forming a certain angle, different from 0 degrees, relative to the optical axis may be achieved.

In one or more example biological fluid analysers, the aperture with a first aperture configuration may have a first shape which is circular, oval, rectangular, squared, non-circular or any other suitable shape. The aperture with a second aperture configuration may have a second shape which is circular, oval, rectangular, squared, non-circular or any other suitable shape. The aperture with a third aperture configuration may have a third shape which is circular, oval, rectangular, squared, non-circular or any other suitable shape.

In one or more example biological fluid analysers, the biological fluid analyser comprises a third lens assembly configured to direct light from the probing volume.

The third lens assembly may help to concentrate the light from the probing volume at converging points downstream of the probing volume, such a rear focal point of the third lens assembly or other converging points along a rear focal plane of the third lens assembly. This may facilitate the interpretation of the biological fluid parameters of the prepared biological fluid sample determined or estimated by the probing light.

In one or more example biological fluid analysers, the biological fluid analyser comprises a light sensor configured to receive light directed by the third lens assembly. The light sensor may advantageously provide a graphic representation or image data of the prepared biological fluid sample. Preferably, the light sensor is disposed at the rear focal plane of the third light assembly. Put another way, the converging points, such as a rear focal point, of the third lens assembly preferably extend along the light sensor. The light sensor may be an image sensor, e.g., a camera with a pixel resolution of at least 1 mega pixel. In one or more example biological fluid analysers, the light sensor is configured to be non-exchangeable. By non-exchangeable is meant that the camera or light sensor is at least not directly accessible during normal operation of the biological fluid analyser and cannot be removed without the removal of parts of the biological fluid analyser separate from the camera or light sensor, such as, e.g., removal of panels for light shielding. This improves the simplicity of the biological fluid analyser and allows for a relatively compact design, as it is not necessary to allow users to easily access and replace the camera or light sensor.

In one or more example biological fluid analysers, the first light configuration comprises a first light pattern. The light source assembly, in response to the first light control signal, may be configured to emit light with the first light pattern. The first light pattern may comprise a first ring having a first inner diameter and a first outer diameter. The first light pattern may comprise a first circle, e.g., centered on the optical axis, the first circle having a first diameter. The second light configuration may comprise a second light pattern. The light source assembly, in response to the second light control signal, may be configured to emit light with the second light pattern. The second light pattern may comprise a second ring having a second inner diameter and a second outer diameter. The first inner diameter may be smaller than the second inner diameter. In one or more example biological fluid analysers, the first outer diameter may be smaller than or equal to the second inner diameter. The second light pattern may comprise a second circle, e.g., centered on the optical axis, the second circle having a second diameter.

By means of a suitable arrangement of the first and second light patterns, the properties of the light emitted by the light source assembly may be efficiently customised. In other words, controlling the light pattern may provide probing light with different incident light settings/incidence angles in turn allowing for improved cell classification based on respective image data of the cells with different incident light settings.

In one or more example biological fluid analysers, the light source assembly comprises an array of light sources. In response to the first light control signal, the array of light sources may be configured to emit light according to a first geometrical pattern corresponding to the first light pattern. In response to the second light control signal, the array of light sources may be configured to emit light according to a second geometrical pattern corresponding to the second light pattern.

The use of geometrical patterns to define the first and second light patterns may advantageously enable a customisation of the light emitted by the light source assembly which is precise, and which can be straightforwardly achieved. For example, the array of light sources may be configured to emit light according to an annular arrangement disposed around an optical axis of the imaging system.

As set out above, the variation of the light emitted by the light source assembly may give rise to corresponding variations in the probing light, which in turn allows for different imaging of cells in the prepared biological fluid sample. For example, the definition of the geometrical pattern of the emitting light sources may influence the incidence angle of the probing light. In an example, a light source placed at the optical axis of the imaging system, when emitting light, may give rise to probing light with 0 degrees of incidence with respect to the optical axis. Light sources placed at increasing distance from the optical axis of the imaging system may give rise to probing light with increasing incidence angles with respect to the optical axis.

In one or more example biological fluid analysers, the light source assembly comprises a glass substrate. The light source assembly, in response to the first light control signal, may be configured to apply a first transparency pattern in the glass substrate for emitting light with the first light configuration. The light source assembly, in response to the second light control signal, may be configured to apply a second transparency pattern in the glass substrate for emitting light with the second light configuration.

The provision of first and second transparency patterns may lead to a versatile and precise selection of different light configurations.

The glass substrate may comprise a liquid crystal display. Liquid crystal displays may be configured to accurately provide varying transparency patterns.

In one or more example biological fluid analysers, the first light configuration comprises a first colour scheme. The light source assembly, in response to the first light control signal, may be configured to emit light having the first colour scheme. The second light configuration may comprise a second colour scheme. The light source assembly, in response to the second light control signal, may be configured to emit light having the second colour scheme. The first colour scheme may be different from the second colour scheme.

Having a first colour scheme and a second colour scheme may lead to probing light with corresponding colour schemes. This may be advantageous to determine or estimate certain biological fluid parameters in a prepared biological fluid sample.

In one or more example biological fluid analysers, the first light configuration comprises a first intensity scheme. The light source assembly, in response to the first light control signal, may be configured to emit light having the first intensity scheme. The second light configuration may comprise a second intensity scheme. The light source assembly, in response to the second light control signal, may be configured to emit light having the second intensity scheme.

Having a first intensity scheme and a second intensity scheme may lead to probing light with corresponding intensity schemes. This may be beneficial to determine or estimate certain properties in a prepared biological fluid sample.

In one or more example biological fluid analysers, the light source assembly, in response to the first light control signal, is configured to emit light decentred from the optical axis. The light source assembly, in response to the second light control signal, may be configured to emit light decentred from the optical axis of the imaging system.

The emission of light decentred from the optical axis may be useful to obtain probing light with suitable characteristics, such as light with suitable incidence angles.

These and other features and advantages of the invention will become more evident in the light of the following detailed description of preferred embodiments, given only by way of illustrative and non-limiting example, in reference to the attached figures.

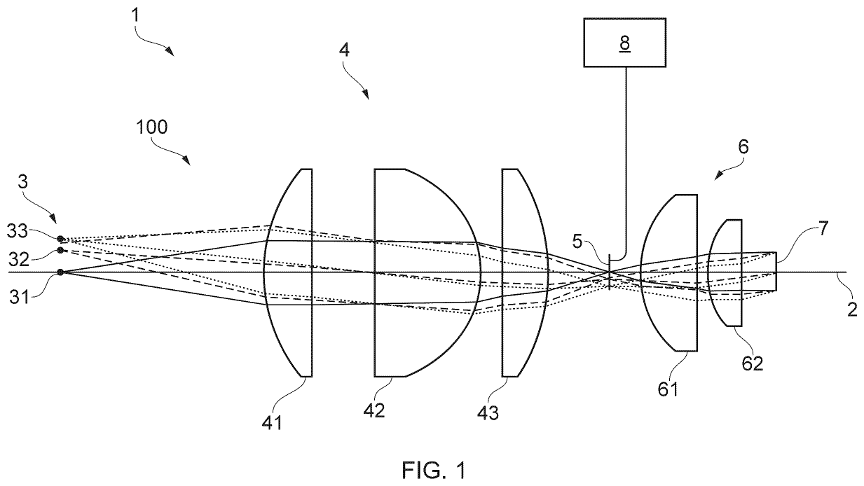

FIG. 1 illustrates a biological fluid analyser 100 comprising an imaging system 1. The imaging system 1 comprises a light source assembly 3 and a first lens assembly 4. An optical axis 2 of the imaging system 1 extends across the light source assembly 3 and the first lens assembly 4. In the embodiment of FIG. 1, the first lens assembly 4 comprises a first lens 41, a second lens 42 and an optional third lens 43. The lenses 41, 42, 43 are configured to direct light emitted by the light source assembly 3 towards converging points downstream of the first lens assembly 4.

The biological fluid analyser of FIG. 1 comprises an aperture device 5 configured to apply an aperture to allow light from the first lens assembly 4 to pass through the aperture. In the example biological fluid analyser of FIG. 1, the aperture device 5 extends along a rear focal plane of the first light assembly 4. The converging points of the light directed by the first lens assembly 4 are located on the rear focal plane of the first lens assembly 4. Therefore, the applied aperture may be selectively applied to comprise one or more of the converging points.

In the embodiment of FIG. 1, the light source assembly comprises one or more of a first light source 31, a second light source 32 and a third light source 33. The first light source 31 is disposed on the optical axis 2 of the imaging system 1. The beams of light emitted by each of the light sources 31, 32, 33 converge at converging points on the rear focal plane of the first lens assembly 4. In the configuration of FIG. 1, the applied aperture in aperture device allows the light emitted by the three light sources 31, 32, 33 to pass through the applied aperture.

In the embodiment of FIG. 1, the probing volume 7, and the potential container comprising the prepared biological fluid sample, are not displaced relative to the light source assembly 3 when the controller 8 sends the first and second aperture control signals.

Downstream of the aperture device 5, the imaging device 1 of the biological fluid analyser 100 of FIG. 1 comprises a second lens assembly 6. In biological fluid analyser 100, the second lens assembly comprises a first lens 62 and/or a second lens 62. The second lens assembly 6 is configured to direct the light passing through the applied aperture in aperture device 5 and to focus the light on a rear focal plane of the second lens assembly 6. FIG. 1 shows that each converging point on the rear focal plane of the first lens assembly 4 gives rise to a different incidence angle on the rear focal plane of the second lens assembly 6. Therefore, the incidence angle of the light directed by the second lens assembly 6 on the rear focal plane of the second lens assembly 6 may be customised by the application of the aperture of the aperture device 5.

In the embodiment of FIG. 1, a probing volume 7 is defined along the rear focal plane of the second lens assembly 6. The probing volume 7 of FIG. 1 receives light having three different incidence angles. The light received by the probing volume 7 is referred to as probing light. Since the light passing through the applied aperture is directed by the second lens assembly 6 to define the probing light, the light passing through the applied aperture indirectly defines the probing light.

The incidence angle or angles of the probing light may be customised by the aperture device 5. In order to achieve such customisation, the biological fluid analyser 100 comprises a controller 8 configured to control the aperture device 5.

The biological fluid analyser 100 comprises a controller 8 configured to control parts of the imaging system 1. For example, the controller 8 may be configured to control the aperture device via one or more aperture control signals to the aperture device 5.

In FIG. 1, the aperture device 5 is controlled by the controller 8 according to an aperture configuration in which the applied aperture has a second aperture configuration. In other words, the controller has sent a second aperture control signal to the aperture device 5. As explained above, the second aperture configuration allows the light converging at the three converging points on the real focal plane of the first lens assembly 4 to pass through the applied aperture.

Since the aperture device 5 of this embodiment extends along the rear focal plane of the first lens assembly 4, the aperture device 5 may carry out a precise filtration of the light directed by the first lens assembly 4 by selectively applying the aperture to comprise one or more of the converging points located on the rear focal plane of the first lens assembly 4. However, the aperture device 5 may also extend along a plane different from the rear focal plane of the first lens assembly 4 and still carry out a suitable filtration of the light directed by the first lens assembly 4.

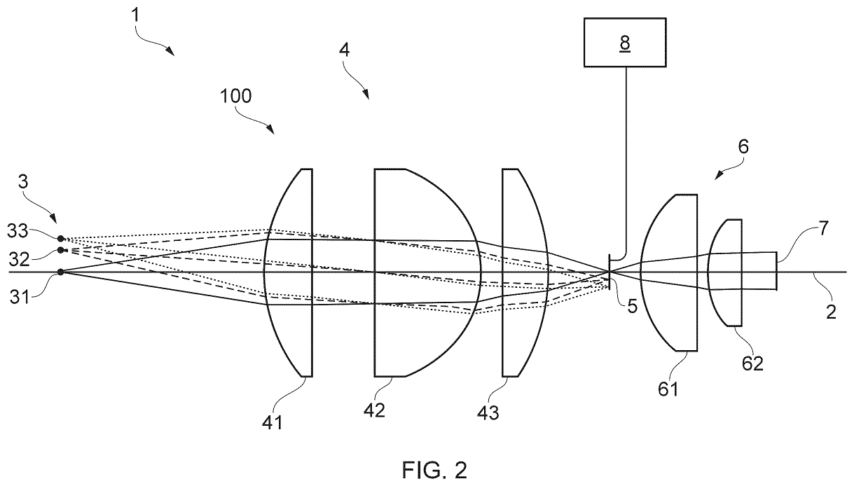

FIG. 2 shows the biological fluid analyser 100 of the embodiment of FIG. 1 when the controller controls the aperture device 5 according to an aperture configuration in which the applied aperture has a first aperture configuration. In other words, the controller has sent a first aperture control signal to the aperture device 5. In the configuration of FIG. 2, the applied aperture allows light originating at the first light source 31 to pass through it. Likewise, the applied aperture blocks light from the remaining light sources 32, 33. This configuration gives right to a probing light with an incidence angle of 0 degrees with respect to the optical axis 2.

The customization of the probing light, such as the customization of the incidence angle of the probing light, may be useful to determine or estimate different blood parameters of a prepared blood sample, such as a classification of blood cell types, when a container comprising the prepared blood sample is received in the probing volume 7.

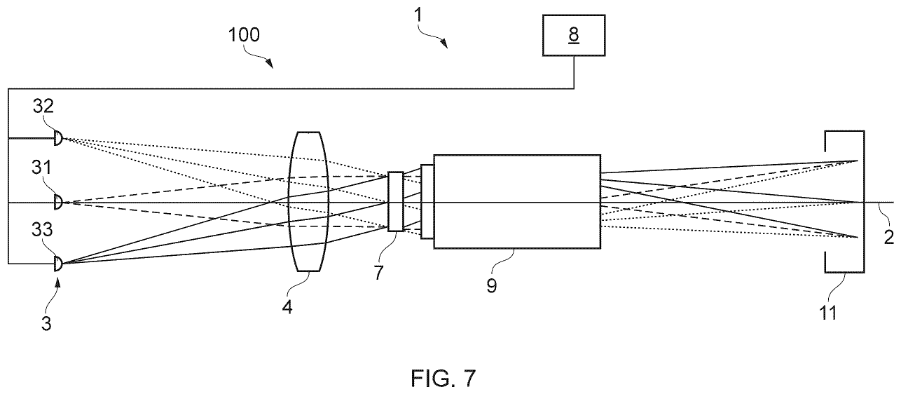

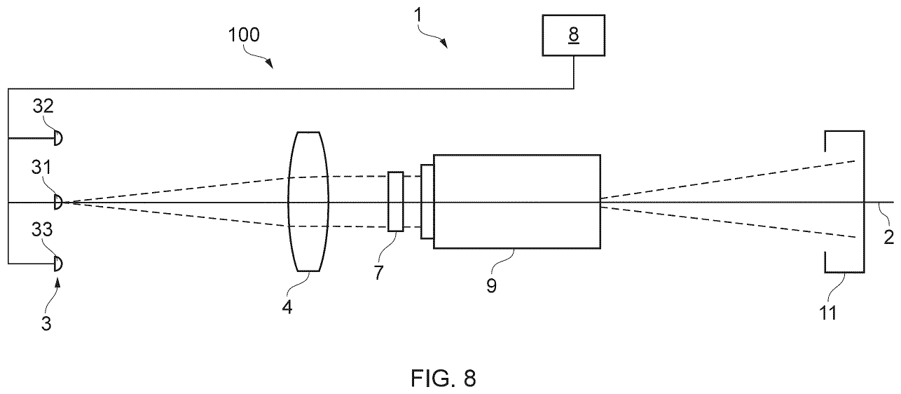

It should be noted that the imaging system 1 of the biological fluid analyser 100 of the embodiment of FIG. 1 and FIG. 2 may comprise a third lens assembly 9 and a light sensor 11 (not represented in FIG. 1 and FIG. 2 for the sake of conciseness) identical to those described for FIG. 7 and FIG. 8 below. As shown in these figures, the third lens assembly 9 and the light sensor 11 would be disposed downstream of the probing volume 7.

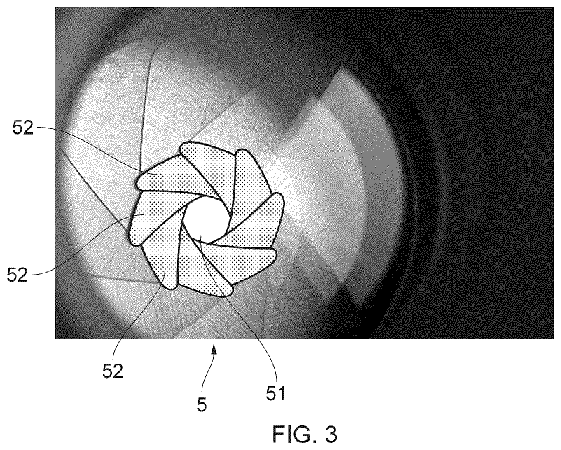

FIG. 3 shows an aperture device 5 comprising a blade aperture 51 delimited by a plurality of blades 52. The controller 8 controls the blades 52 to adjust the blade aperture 51 according to a plurality of aperture configurations including a first aperture configuration and a second aperture configuration. For example, the controller 8 may change the position of the blades 52 to adjust the form, the shape or both the form and the shape of the blade aperture 51.

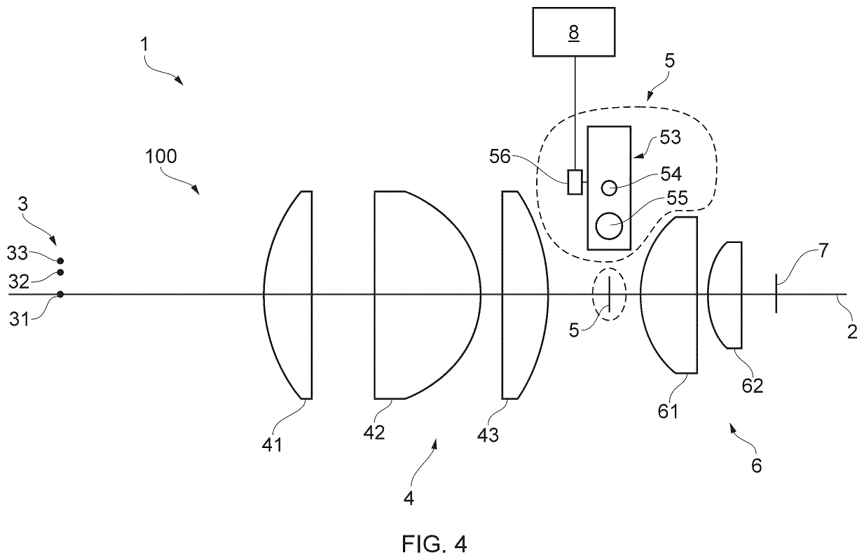

FIG. 4 illustrates an aperture device 5 comprising a plate 53. A cross-sectional schematic view of the plate 53 is represented in the upper part of FIG. 4, within the dotted area. The plate 53 comprises a first plate aperture 54 and a second plate aperture 55 different from the first plate aperture 54. The controller 8 is configured to apply the first plate aperture 54 as an aperture with a first aperture configuration and to apply the second plate aperture 55 as an aperture with a second aperture configuration. In the embodiment of FIG. 4, the aperture with a second aperture configuration may be configured to allow a greater amount of light to pass through the applied aperture. This may yield probing light having a greater number of and larger incidence angles.

In FIG. 4, the aperture device 5 comprises an actuator 56. The actuator 56 may be configured to move the plate 53 to a first position in which the applied aperture is the first plate aperture 54 in response to a first aperture control signal from controller 8. The actuator 56 may be configured to move the plate 53 to a second position in which the applied aperture is the second plate aperture 55, in response to a second aperture control signal from the controller. The actuator 56 may perform such movements by one or more of: rotating and linearly translating the plate 53.

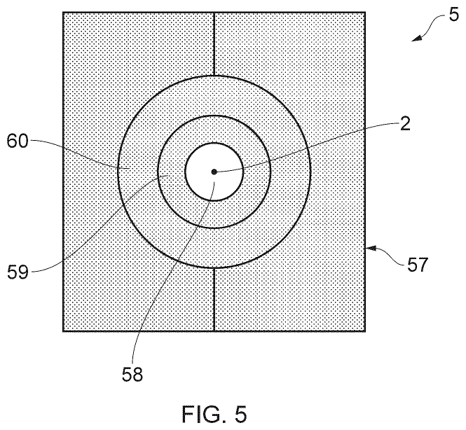

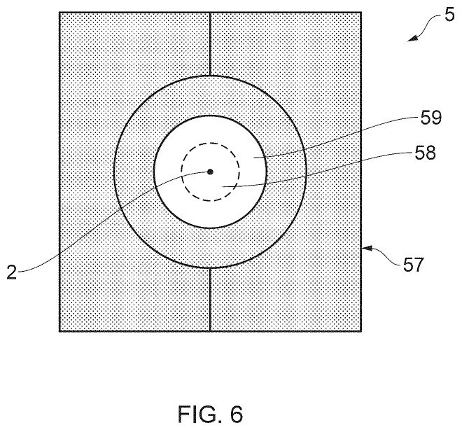

FIG. 5 illustrates an aperture device 5 comprising a glass substrate 57. The glass substrate 57 of FIG. 5 shows a first transparency pattern in which a first circle 58 centred on the optical axis 2 is transparent, whilst two concentric annular rings 59, 60 disposed around the circle 58 are opaque. The first transparency pattern defines an aperture, corresponding to the transparent first circle 58, with a first aperture configuration. The controller 8 is configured to control the transparency pattern of the glass substrate 57 by means of light control signals/aperture control signals. For example, the controller 8 may vary the transparency of the annular ring 59 adjacent the circle 58 to make it transparent in a second transparency pattern. Such second transparency pattern, e.g., as represented in FIG. 6, defines an aperture with a second aperture configuration, having a greater size than the aperture with a first aperture configuration. Therefore, the aperture with a second aperture configuration may be configured to allow a greater amount of light to pass through the applied aperture for provision of probing light with a larger incident angle range than the first aperture configuration.

FIG. 7 depicts a biological fluid analyser 100, such as a blood analyser and/or a cell culture analyser, comprising an imaging system 1. The imaging system 1 comprises a light source assembly 3 and a first lens assembly 4. An optical axis 2 of the imaging system 1 extends across the light source assembly 3 and the first lens assembly 4.

In the embodiment of FIG. 7, the light source assembly comprises a first light source 31, a second light source 32 and a third light source 33. The first light source 31 is disposed on the optical axis 2 of the imaging system 1. The second 32 and third 33 light sources are disposed symmetrically to one another relative to the optical axis 2.

In FIG. 7, the first light assembly 4 comprises a front convex surface and a rear concave surface. The beams of light emitted by each of the light sources 31, 32, 33 converge at converging points on a rear focal plane of the first lens assembly 4. FIG. 7 shows that a beam of light emitted by a certain light source leads to a certain incidence angle on the rear focal plane of the first lens assembly 4. This may depend on the relative position between such light source and the optical axis 2. Therefore, the incidence angle of the light directed by the first lens assembly 4 on the rear focal plane of the first lens assembly 4 may be customised by the selection of a given light configuration of the light source assembly 3.

In the embodiment of FIG. 7, a probing volume 7 is defined along the rear focal plane of the first lens assembly 4. The probing volume 7 of FIG. 7 receives light having three different incidence angles. The light received by the probing volume 7 is referred to as probing light. Since the light directed by the first lens assembly 4 forms the probing light with no optical elements downstream of the first lens assembly 4, the light directed by the first lens assembly 4 directly defines the probing light.

A characteristic of the probing light, such as the incidence angle, may be customised by the light source assembly 3. In order to achieve such customization, the biological fluid analyser 100 comprises a controller 8 configured to control the light source assembly 3.

In FIG. 7, the light source assembly 3 is controlled by the controller 8 according to a light configuration in which the light source assembly has a second light configuration. As explained above, the second light configuration gives rise to light in which the three converging points on the real focal plane of the first lens assembly 4, that is, on the probing volume 7, comprise light with three different incidence angles.

FIG. 8 shows the biological fluid analyser 100 of the embodiment of FIG. 7 when the controller 8 controls the light source assembly 3 according to a first light configuration. In the configuration of FIG. 8, the first light source 31 emits light whilst the second 32 and third 33 light sources do not emit light. This configuration gives rise to a probing light with an incidence angle of 0 degrees with respect to the optical axis 2.

The controller 8 may control the light sources 31, 32, 33 of the light source assembly 3 according to light configurations including light parameters other than, or in addition to, the relative position of the emitting light sources with respect to the optical axis 2. For example, the controller 8 may vary the light intensity of one or more of the light sources 31, 32, 33. For example, the first light source 31 may be a blue LED, the second light source 32 may be a green LED and the third light source may be a red LED. In such example, the second light configuration described above comprises a second colour scheme in which the probing light is white, as a result of the combination of the blue, green and red light rays. The first light configuration described above, in this example, comprises a first colour scheme in which the probing light is blue, as only the blue LED emits light.

The customization of the probing light, such as the customization of the incidence angle, intensity, colour scheme or a combination of these parameters of the probing light, may be useful to identify different biological fluid parameters in a prepared biological fluid sample, such as a classification of blood cell types in a prepared blood sample, when a container comprising the prepared blood sample is received in the probing volume 7.

The imaging system 1 of FIGS. 7 and 8 comprises a third lens assembly 9 configured to direct light from the probing volume 7. The third lens assembly 9 focuses the light from the probing volume 7 at converging points on a rear focal plane of the third lens assembly 9. The biological fluid analyser 1 comprises a light sensor 11 which, in FIGS. 7 and 8, receives light directed by the third lens assembly 9. The light sensor 11 of these Figs is configured for providing a graphic representation of the biological fluid parameters of a prepared biological fluid sample determined or estimated by the probing light, when the prepared biological fluid sample is disposed in a container received in the probing volume 7. In this embodiment, the light sensor 11 is disposed at the rear focal plane of the third lens assembly 9.

The light sensor 7 in FIGS. 7 and 8 is configured to be non-exchangeable and not directly accessible during normal operation of the biological fluid analyser 1. Alternatively, it may be exchangeable.

In the embodiment of FIGS. 7 and 8, the probing volume 7, and the potential container comprising the prepared biological fluid sample, are not displaced relative to the light source assembly 3 when the controller 8 sends the first and second light control signals.

It is noted that the imaging system 1 of the biological fluid analyser 100 of the embodiment of FIG. 7 and FIG. 8 may comprise an aperture device 5 and a second lens assembly 6 identical to those of the embodiment of FIG. 1 and FIG. 2. As shown in these figures, the aperture device 5 and the second lens assembly 6 would be disposed downstream of the first lens assembly 4 and upstream of the probing volume 7.

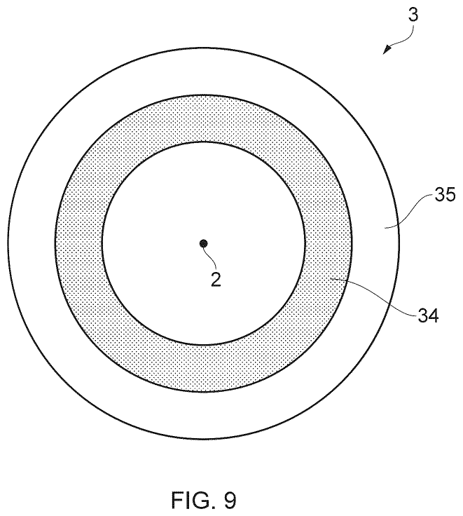

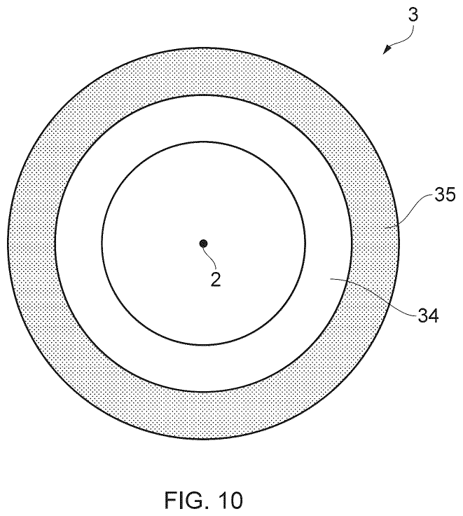

FIGS. 9 and 10 show a light source assembly 3 comprising a first annular light source array 34 and a second annular light source array 35, adjacent and concentric to one another around an optical axis 2. The second annular light source array 35 is disposed externally to the first annular light source array 34, that is, the radius of the second annular light source array 35 is greater than the radius of the first annular light source array 34. A controller 8 controls the light sources that make up the first annular light source array 34 and the second annular light source array 35.

In FIG. 9, the controller 8 sends a first light control signal to the first annular light source array 34 and the second annular light source array 35. The first annular light source array 34 emits light according to a first geometrical pattern having the annular shape of the first annular light source array 34, whilst the second annular light source array 35 emits no light.

In FIG. 10, the controller sends a second light control signal to the first annular light source array 34 and the second annular light source array 35. The second annular light source array 35 emits light according to a second geometrical pattern having the annular shape of the second annular light source array 35, whilst the first annular light source array 34 emits no light.

Both the first and the second geometrical patterns are decentred from the optical axis 2. This may result in probing light with incident angles forming a certain angle, different from 0 degrees, with the optical axis 2. The second geometrical pattern/light pattern may yield probing light having a greater incidence angle than the first geometrical pattern/light pattern.

The use of the terms “first”, “second”, “third” etc. does not imply any particular order but are included to identify individual elements. Moreover, the use of the terms “first”, “second”, “third” etc. does not denote any order or importance but are used to distinguish one element from another. Note that the words “first”, “second”, “third, etc. are used herein and elsewhere for labelling purposes only and are not intended to denote any specific spatial or temporal ordering.

Furthermore, the labelling of a first element does not imply the presence of a second element and vice versa.

It is to be noted that the words “a” or “an” preceding an element do not exclude the presence of a plurality of such elements.

It should further be noted that any reference signs do not limit the scope of the claims, that the disclosed examples and embodiments may be implemented at least in part by means of both hardware and software, and that several “systems” or “devices” may be represented by the same item of hardware.

As used herein with reference to the invention, the terms “upstream” and “front”, and “downstream” and “rear”, are used to describe the relative positions of components, or portions of components, of the biological fluid analyser in relation to the direction in which light travels from the light source assembly to an output of the biological fluid analyser. The biological fluid analyser comprises a proximal end at which the output of the biological fluid analyser is disposed. The proximal end of the biological fluid analyser may also be referred to as the downstream end. The light source assembly is typically located at a distal end. The distal end of the biological fluid analyser may also be referred to as the upstream end. Components, or portions of components, of the biological fluid analyser may be described as being upstream or downstream of one another based on their relative positions between the proximal end and the distal end of the biological fluid analyser. The front of a component, or portion of a component, of the biological fluid analyser is the portion at the end closest to the upstream end of the biological fluid analyser. The rear of a component, or portion of a component, of the biological fluid analyser is the portion at the end closest to the downstream end of the biological fluid analyser. The rear focal plane of a lens assembly is the focal plane closest to the downstream end of the biological fluid analyser. The front focal plane of a lens assembly is the focal plane closest to the upstream end of the biological fluid analyser.

A longitudinal direction corresponds to the direction along which light substantially travels from the light source assembly to an output of the biological fluid analyser. The longitudinal direction is usually the direction of an optical axis of the biological fluid analyser. Put another way, the term “longitudinal” refers to the direction corresponding to the main longitudinal axis of the biological fluid analyser, which extends between the upstream and downstream ends of the biological fluid analyser.

The term “transverse” refers to the direction that is perpendicular to the longitudinal axis. Any reference to the “cross-section” of the biological fluid analyser or a component of the biological fluid analyser refers to the transverse cross-section unless stated otherwise.

The term “length” denotes the dimension of a component of the biological fluid analyser in the longitudinal direction.

Examples of biological fluid analysers according to one or more example biological fluid analysers are set out in the following items:

Item 1. A biological fluid analyser comprising:
an imaging system comprising:
   a light source assembly configured to emit light;
   a first lens assembly configured to direct the light from the light source assembly;
   an aperture device configured to apply an aperture to allow light from the first lens assembly to pass through the aperture in order to indirectly define a probing light;
   the imaging system defining a probing volume configured to receive the probing light and configured to receive a container comprising a prepared biological fluid sample; the biological fluid analyser comprising a controller configured to control the aperture device according to an aperture configuration, wherein the aperture device, in response to a first aperture control signal, is configured to apply an aperture with a first aperture configuration, and wherein the aperture device, in response to a second aperture control signal, is configured to apply an aperture with a second aperture configuration.

Item 2. Biological fluid analyser according to item 1, wherein the imaging system comprises a second lens assembly configured to direct light from the aperture device.

Item 3. Biological fluid analyser according to any one of items 1 to 2, wherein the biological fluid analyser comprises a container configured to contain a prepared biological fluid sample, wherein the container is received in the probing volume.

Item 4. Biological fluid analyser according to item 3, wherein the container comprises a container lens assembly configured to direct light from the aperture device.

Item 5. Biological fluid analyser according to any one of items 1 to 4, wherein the aperture device comprises a blade aperture, and wherein the aperture device, in response to the first aperture control signal, is configured to adjust the blade aperture as the aperture with a first aperture configuration.

Item 6. Biological fluid analyser according to item 5, wherein the aperture device, in response to the second aperture control signal, is configured to adjust the blade aperture as the aperture with a second aperture configuration.

Item 7. Biological fluid analyser according to any one of items 1 to 4, wherein the aperture device comprises a plate with a first plate aperture and a second plate aperture different from the first plate aperture, and wherein the aperture device, in response to the first aperture control signal, is configured to apply the first plate aperture as the aperture with a first aperture configuration.

Item 8. Biological fluid analyser according to item 7, wherein the aperture device comprises an actuator, and wherein the actuator, in response to the first aperture control signal, is configured to move the plate to a first position, and wherein the actuator, in response to the second aperture control signal, is configured to move the plate to a second position.

Item 9. Biological fluid analyser according to any one of items 7 to 8, wherein the aperture device, in response to the second aperture control signal, is configured to apply the second plate aperture as the aperture with a second aperture configuration.

Item 10. Biological fluid analyser according to any one of items 1 to 4, wherein the aperture device comprises a glass substrate, and wherein the aperture device, in response to the first aperture control signal, is configured to apply a first transparency pattern in the glass substrate for provision of the aperture with a first aperture configuration.

Item 11. Biological fluid analyser according to item 10, wherein the glass substrate comprises a liquid crystal display.

Item 12. Biological fluid analyser according to any one of items 10 to 11, wherein the aperture device, in response to the second aperture control signal, is configured to apply a second transparency pattern in the glass substrate for provision of the aperture with a second aperture configuration.

Item 13. Biological fluid analyser according to any one of items 1 to 12, wherein the aperture with a first aperture configuration has a first diameter in the range from 0.5 mm to 4 mm.

Item 14. Biological fluid analyser according to any one of items 1 to 13, wherein the aperture with a second aperture configuration has a second diameter in the range from 2 mm to 8 mm.

Item 15. Biological fluid analyser according to any one of items 1 to 14, wherein to apply an aperture with a first aperture configuration, with a second aperture configuration or both with a first aperture configuration and a second aperture configuration comprises decentring the aperture from an optical axis of the imaging system.

Item 16. Biological fluid analyser according to any one of items 1 to 15, wherein one or more of the aperture with a first aperture configuration and the aperture with a second configuration has an aperture shape, the aperture shape being circular, oval, rectangular or squared.

Item 17. Biological fluid analyser according to any one of items 1 to 16, wherein the aperture device, in response to a third aperture control signal, is configured to apply an aperture with a third aperture configuration.

Item 18. Biological fluid analyser according to any one of items 1 to 17, further comprising a third lens assembly configured to direct light from the probing volume.

Item 19. Biological fluid analyser according to item 18, further comprising a light sensor configured to receive light directed by the third lens assembly.

Item 20. A biological fluid analyser comprising:
an imaging system comprising:
   a light source assembly configured to emit light;
   a first lens assembly configured to direct the light from the light source assembly to directly or indirectly define a probing light;
   the imaging system defining a probing volume configured to receive probing light and configured to receive a container comprising a prepared biological fluid sample;
the biological fluid analyser comprising a controller configured to control the light source assembly according to a light configuration, wherein the light source assembly, in response to a first light control signal, is configured to emit light according to a first light configuration, and wherein the light source assembly, in response to a second light control signal, is configured to emit light according to a second light configuration different from the first light configuration.

Item 21. Biological fluid analyser according to item 20, wherein the imaging system comprises an aperture device configured to apply an aperture to allow light from the first lens assembly to pass through the aperture.

Item 22. Biological fluid analyser according to item 21, wherein the imaging system comprises a second lens assembly configured to direct light from the aperture device.

Item 23. Biological fluid analyser according to any one of items 20 to 22, wherein the biological fluid analyser comprises a container configured to contain a prepared biological fluid sample, and wherein the container is arranged in the probing volume.

Item 24. Biological fluid analyser according to items 21 and 23, wherein the container comprises a container lens assembly configured to direct light from the aperture device.

Item 25. Biological fluid analyser according to any one of items 20 to 24, wherein the first light configuration comprises a first light pattern, and wherein the light source assembly, in response to the first light control signal, is configured to emit light with the first light pattern.

Item 26. Biological fluid analyser according to item 25, wherein the second light configuration comprises a second light pattern, and wherein the light source assembly, in response to the second light control signal, is configured to emit light with the second light pattern.

Item 27. Biological fluid analyser according to item 26, wherein the light source assembly comprises an array of light sources; wherein, in response to the first light control signal, the array of light sources is configured to emit light according to a first geometrical pattern corresponding to the first light pattern; and wherein, in response to the second light control signal, the array of light sources is configured to emit light according to a second geometrical pattern corresponding to the second light pattern.

Item 28. Biological fluid analyser according to any one of items 20 to 27, wherein the light source assembly comprises a glass substrate, and wherein the light source assembly, in response to the first light control signal, is configured to apply a first transparency pattern in the glass substrate for emitting light with the first light configuration, and wherein the light source assembly, in response to the second light control signal, is configured to apply a second transparency pattern in the glass substrate for emitting light with the second light configuration.

Item 29. Biological fluid analyser according to item 28, wherein the glass substrate comprises a liquid crystal display.

Item 30. Biological fluid analyser according to any one of items 20 to 29, wherein the first light configuration comprises a first colour scheme, and wherein the light source assembly, in response to the first light control signal, is configured to emit light having the first colour scheme.

Item 31. Biological fluid analyser according to any one of items 20 to 30, wherein the second light configuration comprises a second colour scheme, and wherein the light source assembly, in response to the second light control signal, is configured to emit light having the second colour scheme.

Item 32. Biological fluid analyser according to any one of items 20 to 31, wherein the first light configuration comprises a first intensity scheme, and wherein the light source assembly, in response to the first light control signal, is configured to emit light having the first intensity scheme.

Item 33. Biological fluid analyser according to any one of items 20 to 32, wherein the second light configuration comprises a second intensity scheme, and wherein the light source assembly, in response to the second light control signal, is configured to emit light having the second intensity scheme.

Item 34. Biological fluid analyser according to any one of items 20 to 33, wherein the light source assembly, in response to a third light control signal from the controller, is configured to emit light according to a third light configuration.

Item 35. Biological fluid analyser according to any one of items 20 to 34, wherein the light source assembly, in response to one or more of the first and the second light control signals, is configured to emit light decentred from an optical axis of the imaging system.

Item 36. Biological fluid analyser according to any one of items 20 to 35, wherein the imaging system comprises a third lens assembly configured to direct light from the probing volume.

Item 37. Biological fluid analyser according to item 36, wherein the imaging system comprises a light sensor configured to receive light directed by the third lens assembly.

Item 38. Biological fluid analyser according to any one of items 20 to 35, wherein the biological fluid analyser is a biological fluid analyser according to any of items 1 to 19.

Item 39. A biological fluid analyser comprising:
an imaging system comprising:
   a light source assembly configured to emit light;
   a first lens assembly configured to direct the light from the light source assembly to directly or indirectly define a probing light;
   the imaging system defining a probing volume configured to receive probing light and configured to receive a container comprising a prepared biological fluid sample;
the biological fluid analyser comprising a controller, the controller being configured to control the imaging system, according to a probing light configuration.

Item 40. Biological fluid analyser of item 39, wherein the imaging system, in response to a first probing light control signal, is configured according to a first probing light configuration, and wherein the imaging system, in response to a second probing light control signal, is configured according to a second probing light configuration.

Item 41. Biological fluid analyser of item 40, wherein the first probing light configuration, the second probing light configuration or both the first probing light configuration and the second probing light configuration comprise one or more of: an incidence angle configuration, a light configuration and an aperture configuration.

Item 42. Biological fluid analyser according to any one of items 39 to 41, wherein the biological fluid analyser is a biological fluid analyser according to item 38.

Item 43. Biological fluid analyser according to any one of items 1 to 42, wherein the biological fluid analyser is a biological fluid analyser.

Item 44. Biological fluid analyser according to any one of items 1 to 42, wherein the biological fluid analyser is a cell culture analyser.

### LIST OF REFERENCES

1 Biological fluid analyser
2 Optical axis
3 Light source assembly
4 First lens assembly
5 Aperture device
6 Second lens assembly
7 Probing volume
8 Controller
9 Third lens assembly
11 Light sensor
31 First light source
32 Second light source
33 Third light source
34 First annular light source array
35 Second annular light source array
41 First lens of the first lens assembly
42 Second lens of the first lens assembly
43 Third lens of the first lens assembly
51 Blade aperture
52 Blade
53 Plate
54 First plate aperture
55 Second plate aperture
56 Actuator
57 Glass substrate
58 Circle
59, 60 Annular rings
61 First lens of the second lens assembly
62 Second lens of the second lens assembly

1. A biological fluid analyzer comprising:
an imaging system comprising:
a light source assembly configured to emit light,
a first lens assembly configured to direct the light from the light source assembly to directly or indirectly define a probing light, and
the imaging system defining a probing volume configured to receive the probing light and configured to receive a container comprising a prepared biological fluid sample; and
a controller configured to control the light source assembly according to a light configuration, wherein the light source assembly, in response to a first light control signal, is configured to emit light according to a first light configuration, and wherein the light source assembly, in response to a second light control signal, is configured to emit light according to a second light configuration.

2. The biological fluid analyzer according to claim 1, wherein the imaging system comprises an aperture device configured to apply an aperture to allow light from the first lens assembly to pass through the aperture, and wherein the imaging system further comprises a second lens assembly configured to direct light from the aperture device.

3. The biological fluid analyzer according to claim 1, wherein the biological fluid analyzer comprises a container configured to contain a prepared biological fluid sample, and wherein the container is arranged in the probing volume.

4. The biological fluid analyzer according to claim 1, wherein the first light configuration comprises a first light pattern, and wherein the light source assembly, in response to the first light control signal, is configured to emit light with the first light pattern.

5. The biological fluid analyzer according to claim 4, wherein the second light configuration comprises a second light pattern, and wherein the light source assembly, in response to the second light control signal, is configured to emit light with the second light pattern.

6. The biological fluid analyzer according to claim 5, wherein the light source assembly comprises an array of light sources; wherein, in response to the first light control signal, the array of light sources is configured to emit light according to a first geometrical pattern corresponding to the first light pattern; and wherein, in response to the second light control signal, the array of light sources is configured to emit light according to a second geometrical pattern corresponding to the second light pattern.

7. The biological fluid analyzer according to claim 1, wherein the light source assembly comprises a glass substrate comprising a liquid crystal display, and wherein the light source assembly, in response to the first light control signal, is configured to apply a first transparency pattern in the glass substrate for emitting light with the first light configuration, and wherein the light source assembly, in response to the second light control signal, is configured to apply a second transparency pattern in the glass substrate for emitting light with the second light configuration.

8. The biological fluid analyzer according to claim 1, wherein the first light configuration comprises a first color scheme, and wherein the light source assembly, in response to the first light control signal, is configured to emit light having the first color scheme, and wherein the second light configuration comprises a second color scheme, and wherein the light source assembly, in response to the second light control signal, is configured to emit light having the second color scheme.

9. The biological fluid analyzer according to claim 1, wherein the first light configuration comprises a first intensity scheme, and wherein the light source assembly, in response to the first light control signal, is configured to emit light having the first intensity scheme.

10. The biological fluid analyzer according to claim 1, wherein the second light configuration comprises a second intensity scheme, and wherein the light source assembly, in response to the second light control signal, is configured to emit light having the second intensity scheme.

11. The biological fluid analyzer according to claim 1, wherein the light source assembly, in response to a third light control signal from the controller, is configured to emit light according to a third light configuration.

12. The biological fluid analyzer according to claim 1, wherein the light source assembly, in response to one or more of the first and the second light control signals, is configured to emit light decentred from an optical axis of the imaging system.

13. The biological fluid analyzer according to claim 1, wherein the imaging system comprises a third lens assembly configured to direct light from the probing volume and a light sensor configured to receive light directed by the third lens assembly.
